(19) United States
(12) Patent Application Publication
(10) Pub. No.: US 2023/0353636 A1
(43) Pub. Date: Nov. 2, 2023

(54) SIGNAL PROCESSING DEVICE, GATEWAY, MANAGEMENT SERVER AND METHOD

(71) Applicant: ROHDE & SCHWARZ GMBH & CO. KG, München (DE)

(72) Inventors: Thomas BRAUNSTORFINGER, München (DE); Bjoern SCHMID, München (DE); Stefan WETH, Markt Schwaben (DE); Bernhard STERZBACH, München (DE)

(21) Appl. No.: 17/731,761

(22) Filed: Apr. 28, 2022

(51) Int. Cl. H04L 67/12; H04L 67/02; H04L 67/1087

(52) U.S. Cl. CPC H04L 67/12; H04L 67/02; H04L 67/1091

(57) ABSTRACT

The present disclosure provides a signal processing device comprising a communication interface for communicatively coupling the measurement device to a management server; and a communication processor for exchanging device data with the management server. In addition, the present disclosure provides a gateway, a management server and a respective method for managing at least one signal processing device.

### TECHNICAL FIELD

The disclosure relates to a signal processing device, a gateway, a management server and a respective method.

### BACKGROUND

Although applicable to any type of signal processing devices, the present disclosure will mainly be described in conjunction with measurement devices and signal generation devices.

Managing a plurality of signal processing devices, like oscilloscopes or signal generators, may be a complicated task. Especially when a large number of devices is present, monitoring the devices and keeping the software of the devices updated is a cumbersome task.

Accordingly, there is a need for simplifying management of signal processing devices.

### SUMMARY

The above stated problem is solved by the features of the independent claims. It is understood, that independent claims of a claim category may be formed in analogy to the dependent claims of another claim category.

Accordingly, it is provided:

A signal processing device comprising a communication interface for communicatively coupling the measurement device to a management server; and a communication processor for exchanging device data with the management server.

Further, it is provided:

A gateway comprising a device communication interface for communicating with at least one signal processing device; a server communication interface for communicating with a management server; and a communication processor for communicating data between the device communication interface and the server communication interface based on requests provided by at least one of the at least one signal processing device and the management server.

In addition, it is provided:

A management server comprising a device communication interface for communicating directly or indirectly with at least one signal processing device; a device data storage for storing device data; and a communication processor that is coupled to the device communication interface and the device data storage for exchanging device data with the at least one signal processing device.

Further, it is provided:

A device management system comprising at least one signal processing device according to the present disclosure that is communicatively coupled to a management server according to the present disclosure either directly or indirectly via any type and combination of communication networks.

In addition, it is provided:

A method for managing at least one signal processing device, the method comprising providing device data in the at least one signal processing device; and exchanging the device data between the at least one signal processing device and a management server.

The present disclosure is based on the finding that modern signal processing devices, like oscilloscopes, network analyzers or signal generators, need regular services for example for upgrading a firmware, verifying and performing calibration and other maintenance activities.

For a user it is usually not possible or at least requires some effort to perform such upgrades. For verifying and performing calibration the respective device usually needs to be sent back to the manufacturer.

The present disclosure acknowledges that users want to simplify maintenance of their signal processing devices and therefore provides a signal processing device with extended communication capabilities. The signal processing device in the context of the present disclosure may for example comprise, but is not limited to, an oscilloscope, a network analyzer, especially a vector network analyzer, a signal generator, like a broadcast signal generator, and signal analyzers.

The signal processing device comprises a communication interface and a respective communication processor. The communication interface serves for coupling the signal processing device communicatively with a management server, and the communication processor exchanges device data with the management server via the communication interface.

The management server may be any kind of server that may be accessible for the signal processing device directly or indirectly via the communication interface. To this end, the management server comprises a device communication interface. In addition, the management server comprises a device data storage that stores device data and a communication processor that communicates with at least one signal processing device via the device communication interface.

It is understood, that the communication interface of the device and the device communication interface of the management server may comprise any kind of wired and wireless communication interfaces, like for example a network communication interface, especially an Ethernet, wireless LAN or WIFI interface, a USB interface, a Bluetooth interface, an NFC interface, a visible or non-visible light-based interface, especially an infrared interface. The same applies to the communication interface of the gateway. Generally, it is understood, that every interface that is capable of data communication may comprise a controller that receives digital data and performs data management according to the respective communication protocol, and may comprise a PHY or physical section that translates digital data into physical signals on or in a medium, like wires or air. The communication interfaces may also comprise respective functions or APIs in an operating system of the respective device.

It is further understood, that the signal processing device and the management server may communicate via a network with each other, and that such a network may comprise any type of network devices, like switches, hubs, routers, firewalls, and different types of network technologies between the management server and the signal processing device.

The management server may be a dedicated server that may be implemented as a single hardware device, like a computer or PC. The management server may also be implemented as a distributed system comprising a plurality of servers, optionally with a load balancer, that distributes the load over the servers. The management server may also be provided as a so-called cloud or cloud-server system that implements the management server via virtualization methods independently of the underlying hardware.

The present disclosure therefore allows the signal processing device to exchange device data with the management server without a user being required to perform any activities. Of course, the signal processing device may require the user to activate the data exchange or to agree to the data exchange prior to exchanging the data.

Device data in the context of the present disclosure may refer to any data referring to a respective signal processing device. It is understood, that the term device data refers to data that may be provided from the signal processing device to the management server or to data that may be provided from the management server to the signal processing device.

The device data may for example comprise status information of the signal processing device, like at least one of a device name, a firmware version, a hardware revision, a device footprint and a list of applications installed in the signal processing device. With such information being provided from the signal processing device to the management server, the management server may keep a list that contains the details about the respective signal processing devices and use this information to provide specific device data to the signal processing devices, like adequate firmware updates. It is understood, that the term “application” that may be installed in the signal processing device in the context of the present disclosure refers to additional functions that may be provided in the signal processing device that do not form part of the basic or minimum functionality of the signal processing device. Such applications may for example be installed in response to a request of a user, other applications may be pre-installed by the manufacturer of the signal processing device. Applications may also be removed, in contrast to the function of the firmware of the signal processing device, e.g., if the available memory is low.

The device data may also comprise updates for the firmware or for additional application software or for parameters of the signal processing device that may be provided by the management server. This device data allows updating the signal processing device via the management server as soon as a new firmware, application or parameter set is published by the manufacturer of the signal processing device. Of course, the device data may also comprise information about any updates that may be available for a signal processing device, that may be displayed to a user prior to transmitting the actual updates.

In addition, or as alternative, the device data may also comprise log files of the signal processing device, and crash reports generated in the signal processing device when an error occurred during execution of a firmware function or an application. Such device data allows evaluating the performance of the signal processing device by the management server and identifying possible problems. Especially, log files and crash reports may also be used by the manufacturer of the signal processing device to identify problems and provide an updated firmware or application software.

The device data may also comprise health data for the signal processing device, like temperatures, self-test data, monitoring data of monitored conditions or parameters of the signal processing device and actuation times of input devices. The health data allows the management server to perform a continuous monitoring and to perform predictive maintenance in that the management server may assess the status of the signal processing device based on the health data. The management server may for example calculate an estimated time of failure or an estimated date for the next needed calibration of the signal processing device based on such device data. Such kind of data may also be called HUMS data, Health and Usage Monitoring Data.

The device data may also comprise utilization data. The utilization data may comprise details about how a user interacts with the signal processing device and which functions of the signal processing device the user uses in which states of the signal processing device. The device data may also comprise information about the usage or utilization of additional applications provided in the signal processing device. This data may also be called telemetry data. With such device data the manufacturer of the signal processing device may identify the key functions that the users use most and may identify possible improvements of the user interface and the firmware or application software in the signal processing device. Utilization data and telemetry data also allows to track the usage of certain functions in the signal processing device. This data may be used to prioritize functions during development of signal processing devices. Further, it is possible to identify complicated control sequences that have to be performed by a user and to simplify these sequences in further development of the signal processing device. In addition, this data may be used to perform billing of the usage.

The device data may also comprise service data. Service data my comprise any data that refers to services performed or to be performed with the signal processing device. The service data may for example comprise the date of the last service that was performed with the signal processing device and the estimated date of the next service that should be performed. The management server may for example determine the date for the next service based on other device data, like the health data and/or the utilization data.

The device data may also comprise raw data, for example raw measurement data that represents a measured signal or a generated signal, or I/Q-data of a measured signal or a generated signal, that may be provided from the signal processing device to the management server. The device data may also comprise resulting data, like waveforms and EVM readings, that the management server calculates based on received device data.

The device data may also comprise application notes or manuals that may be provided by the management server for a specific signal processing device.

Other types of device data may also comprise billing data. Such billing data may for example comprise a usage information provided by the signal processing device for functions that may be paid per use or may be activated for a specific amount of time for a certain fee. The billing data may also comprise actual cost information that may be determined by the management server and may be provided to the signal processing device. Such cost information may in embodiments be determined in real time by the management server when a user of a signal processing device requests a specific function in the signal processing device.

In the signal processing device, the communication processor manages the data exchange with the management server via the communication interface.

To this end the communication processor may be provided as a dedicated processing element, like e.g., a processing unit, a microcontroller, an FPGA, a CPLD or the like. The communication processor may at least in part also be provided as a computer program product comprising computer readable instructions that may be executed by a processing element. In a further embodiment, the processor may be provided as addition or additional function or method to the firmware or operating system of a processing element that is already present in the respective application as respective computer readable instructions. Such computer readable instructions may be stored in a memory that is coupled to or integrated into the processing element. The processing element may load the computer readable instructions from the memory and execute them.

In addition, it is understood, that any required supporting or additional hardware may be provided like e.g., a power supply circuitry and clock generation circuitry.

In case the communication processor is implemented as additional function of the firmware of the signal processing device, the communication processor may use all resources that are available to the firmware of the signal processing device, like any communication interfaces, memories, and user interfaces that the signal processing device may comprise.

The communication processor may provide a kind of data aggregation and collection service or function in the signal processing device to collect the device data that is to be sent to the management server and to receive device data from the management server and forward the received device data to the respective elements or functions of the signal processing device.

The communication processor may for example comprise a function that updates the firmware of the signal processing device after a new firmware version is received from the management server, or a function that displays application notes or billing information on the display of the signal processing device.

Of course, the communication processor and the management server may perform any kind of authentication and authorization prior to initiating a data exchange. For example, the communication processor may authenticate at the management server via a username and a password. The same applies to the management server that may authenticate at the signal processing device with a username and a password. Of course, security may be improved by use of a two-factor authentication or the like.

In addition, or as alternative, the signal processing device may use a certificate-based or cryptographic key-based authentication with the management server. The same applies to the management server that may use a certificate-based or cryptographic key-based authentication with the signal processing device.

The signal processing device may also comprise an input device that may be coupled to the communication processor for receiving a user input. The input device may serve for a user to actively initiate the data exchange with the management server. The communication processor may for example wait for a respective user input prior to sending device data to the management server or prior to accepting incoming data from the management server.

The signal processing device and the management server according to the present disclosure allow easily managing signal processing devices on site at a user's location without the user being required to actively perform any maintenance steps.

The present disclosure further provides the gateway that decouples signal processing devices from any public network.

To this end, the gateway comprises a device communication interface that performs the communication with the signal processing devices. The gateway further comprises a server communication interface that performs the communication with the management server. The gateway further comprises a communication processor that handles the data communication between the signal processing devices and the management server based on requests provided by at least one of the signal processing device or the management server.

The gateway bundles the data communication between the signal processing devices and the gateway and allows indirectly coupling a plurality of signal processing devices to a public network without exposing all of the signal processing devices via said public network.

The requests in this context may refer to requests that are provided by the management server for example, when a user tries to access a signal processing device via a front end, for example a website, provided by the management server. The requests may also refer to requests that are provided by the signal processing device for example, when a user wants to retrieve the most recent device data from the management server.

With the gateway according to the present disclosure, the signal processing devices may be operated in a protected environment, wherein only the gateway is accessible via a public network or has access to a public network. With the gateway the security of the signal processing device and the device data may therefore be increased.

A device management system according to the present disclosure may comprise at least one signal processing device according to the present disclosure that is communicatively coupled to a management server according to the present disclosure either directly or indirectly via any type and combination of communication networks.

In the device management system, the signal processing device may be coupled to the management server indirectly via a gateway according to the present disclosure.

Any of the explanations regarding the signal processing device of the present disclosure, the management server of the present disclosure and the gateway of the present disclosure apply to the components of the device management system accordingly.

Further embodiments of the present disclosure are subject of the further dependent claims and of the following description, referring to the drawings.

In an embodiment, the communication processor may communicate with the management server indirectly by exchanging the device data with a gateway.

The gateway may be provided on the premises of the user of the signal processing device and may be seen as a kind of centralized data aggregator for multiple signal processing devices that may be present on the premises of the user. Of course, a single gateway may be used for multiple signal processing devices.

By using a gateway, all signal processing devices may be kept separate of any public network access to protect that signal processing devices as well as the measurement data in the signal processing devices from unauthorized access.

The signal processing device may further offload processing tasks to the gateway or via the gateway to the management server. The term “processing task” in this regard refers to a task or function that performs calculations that are to be performed, usually with measurement data, and that cause high work load for example on a processor of the signal processing device. The gateway may, therefore, at least in part also serve as a local management server.

In another embodiment, the signal processing device may comprise a gateway memory for storing at least one address of a gateway, wherein the communication processor may communicate with the management server indirectly by exchanging the device data with a gateway at one of the stored addresses.

The gateway may have a specific gateway address that may be stored in the gateway memory of the signal processing device. If multiple addresses are stored for different gateways, the signal processing device may select the gateway with the best connection metrics e.g., the lowest ping, the highest data rate, and may switch to another gateway, if the gateway currently used by the signal processing device fails or loses the connection to the signal processing device.

The gateway memory may comprise any type of memory unit or memory device, like for example a RAM, ROM, E(E)PROM, a hard disk, an SSD disk or the like. The gateway memory may also be provided as part of a memory that is already present in the respective application i.e., in the signal processing device. The gateway memory may for example be provided as a variable or an array of variables that is stored in a memory of the signal processing device.

In a further embodiment, the communication interface may comprise at least one of a wired network interface and/or a wireless network interface, and may communicate within at least one of a virtual local area network, also called a VLAN, and a virtual private network, also called VPN.

The wired network interface may for example comprise an Ethernet interface. A wireless network interface may for example comprise a WIFI interface. It is understood, that the network interface is not limited to these examples.

By using a VLAN or a VPN, multiple measurement devices may be coupled to each other in a protected network. The VLAN may for example only be accessible via a respective gateway or firewall. A VLAN may especially be used with signal processing devices that may be physically coupled to the same network and/or are located at a common location. Further, a VLAN serves to separate network traffic of different devices, even if the data is transmitted via the same cables.

For example, a device VLAN and an office VLAN may be created in the same network. The device VLAN may be provided for the signal processing devices, while the office VLAN may be provided for other devices, like office PCs.

In addition, or as alternative, a VPN may be created to communicatively couple signal processing devices together or to couple a signal processing device with a gateway. The VPN allows providing a secure communication also over large distances, that may not be covered by a single VLAN.

In an embodiment, the communication processor may also use transport encryption for the communication with the management server or the gateway, like for example TLS or SSL encryption. With such an encryption, all the device data is encrypted prior to transmission on any network. To this end, the management server may be provided with a respective TLS or SSL-Certificate. Of course, the same applies to the gateway.

The signal processing device may also comprise a certificate, like a TLS or SSL-Certificate, to perform encrypted communication. This may be especially beneficial if the signal processing devices communicate with each other and not with the gateway or the management server, or when a communication to a signal processing device is initiated by the gateway or the management server.

In yet another embodiment, the signal processing device may comprise a data memory that is coupled to the communication processor or integrated into the communication processor for storing outgoing device data prior to exchanging the outgoing device data with the management server.

The data memory of the signal processing device serves as a kind of cache for the device data and allows the signal processing device to store the device data, either to be sent to or to be received from the management server.

Situations in which neither the gateway nor the management server may be contacted may occur for example when the network between the signal processing device and the gateway is not available e.g., with a failure of the network.

The signal processing device may store the device data that may be generated during such times in the data memory and provide the device data to the gateway or the management server as soon as the network is available again.

In an embodiment, the signal processing device may comprise a data controller that is coupled to the communication interface and the communication processor or that is integrated into the communication processor for controlling a data flow of outgoing and incoming device data.

The data controller may have the function of a firewall and may control how and what data is allowed into and out of the signal processing device.

The data controller may be provided as a dedicated processing element, like e.g., a processing unit, a microcontroller, an FPGA, a CPLD or the like. The data controller may at least in part also be provided as a computer program product comprising computer readable instructions that may be executed by a processing element. In a further embodiment, the data controller may be provided as addition or additional function or method to the firmware or operating system of a processing element that is already present in the respective application as respective computer readable instructions, for example a processor of the signal processing device or the communication processor. Such computer readable instructions may be stored in a memory that is coupled to or integrated into the processing element. The processing element may load the computer readable instructions from the memory and execute them.

In addition, it is understood, that any required supporting or additional hardware may be provided like e.g., a power supply circuitry and clock generation circuitry.

In case that the communication interface is a network interface, the data controller of the signal processing device may for example limit the ports on which connections to the signal processing device may be established or via which the signal processing device may establish connections.

In an embodiment, the data exchange may for example be performed via a REST-API on the gateway or the management server, and the data controller may allow incoming and outgoing data traffic only on TCP port 443 for SSL or TLS encrypted data traffic.

In an embodiment, the data controller of the signal processing device may comprise a VPN client and/or a VPN server to establish a VPN connection and transmit any data only through the VPN connection.

The data controller of the signal processing device may also comprise a function for inspecting the contents of the received data, like a deep packet inspection function or a web application firewall function. With such a function, even if malicious data is injected somehow into the communication between the signal processing device and other devices, the malicious data may still be identified and a respective alarm may be signaled and/or the communication may be interrupted.

In another embodiment, the data controller of the signal processing device may comprise a data router that communicates with other signal processing devices via at least one of the virtual local area network and the virtual private network, and with the management server directly or via a gateway over a different network e.g., at least one of a different virtual local area network or a different virtual private network.

The data router in the signal processing device allows using one of the signal processing devices as a kind of secure gateway for other signal processing devices, that may not support the communication with increased security of the present disclosure. The data router may also implement any of the functions of the gateway according to the present disclosure and act as a gateway for the further signal processing devices.

The data router may be provided as a dedicated processing element, like e.g., a processing unit, a microcontroller, an FPGA, a CPLD or the like. The data router may at least in part also be provided as a computer program product comprising computer readable instructions that may be executed by a processing element. In a further embodiment, the data router may be provided as addition or additional function or method to the firmware or operating system of a processing element that is already present in the respective application as respective computer readable instructions, for example a processor of the signal processing device or the communication processor. Such computer readable instructions may be stored in a memory that is coupled to or integrated into the processing element. The processing element may load the computer readable instructions from the memory and execute them.

In addition, it is understood, that any required supporting or additional hardware may be provided like e.g., a power supply circuitry and clock generation circuitry.

In a laboratory or development site or production site a plurality of different signal processing devices, like measurement devices and signal generation devices may be present. With such a mix of different devices, at least some of the devices may not be capable of securely communicating with a management server or with a gateway.

The signal processing device with the data router my therefore couple to the other signal processing devices e.g., via a VPN or via a VLAN, or a dedicated communication interface . The signal processing device may retrieve device data and provide device data to these other signal processing devices that the signal processing device provides to or receives from a gateway or a management server.

Of course, the signal processing device may also implement network or communication protocols for communicating with the other signal processing devices that may be specific to these other signal processing devices. Such protocols may for example comprise the SCPI protocol.

Regarding the communication with the gateway or the management server, the data router may implement all the features as described in this disclosure for the communication controller of the signal processing device.

In embodiments, the data router may comprise or be coupled to an additional communication interface that allows the data router to communicate with other signal processing devices. Such a communication interface may for example comprise an additional network interface, an optical interface, like an infrared-based or a visible light-based communication interface or a bus interface capable of communicating with the additional signal processing devices.

In a further embodiment, the communication processor of the signal processing device may comprise an application server for exchanging the device data via at least one of HTTP-based communication, REST-based communication, SOAP-based communication, Corba-based communication, or communication via a proprietary protocol.

The application server for example allows the signal processing device to serve a web page for a user to communicate with the signal processing device that may be accessed with any browser application from any device or to provide an API-based access for other devices. The term “SOAP” in this regard refers to the “Simple Object Access Protocol”, the term “Corba” in this regard refers to “Common Object Request Broker Architecture”, and REST refers to “Representational State Transfer”. Of course, the application server may also provide a proprietary access, for example via a proprietary API. In addition, as described above, the access to the signal processing device may be limited for example by at least one of authorization mechanisms, the data controller and encryption of the communication.

The application server may be provided as a dedicated processing element like e.g., a processing unit, a microcontroller, an FPGA, a CPLD or the like. The application server may at least in part also be provided as a computer program product comprising computer readable instructions that may be executed by a processing element. In a further embodiment, the application server may be provided as addition or additional function or method to the firmware or operating system of a processing element that is already present in the respective application as respective computer readable instructions, for example a processor of the signal processing device or the communication processor. Such computer readable instructions may be stored in a memory that is coupled to or integrated into the processing element. Such computer readable instructions may be stored in a memory that is coupled to or integrated into the processing element. The processing element may load the computer readable instructions from the memory and execute them.

In addition, it is understood, that any required supporting or additional hardware may be provided like e.g., a power supply circuitry and clock generation circuitry.

In an embodiment, the application server may serve a website, for example a website built using HTML and optionally also a scripting language, like JavaScript, or TypeScript. Such a website may be accessed for example with a web browser application. The web browser application may be executed on any user device. In embodiments, the web browser application may also be executed on the gateway. The gateway may for example be provided as a computer with a web browser application being executed on the computer.

In an embodiment, the function of the gateway is implemented entirely by the website that is loaded from the signal processing device or the management server and is displayed on a display of a respective computer.

In such embodiments, the data exchange between the signal processing device and the management server may for example be initiated by a user by visiting the website at the network address of the signal processing device. Consequently, in such embodiments the signal processing device is the starting point of the data exchange.

The communication processor of the signal processing device may for example automatically contact the management server as soon as the website is requested by a user. As alternative, the website may comprise a switch or button that activates the communication with the management server. In such an alternative, the communication processor will only contact the management server after the user activates the communication.

The communication processor of the signal processing device may provide the user with an indication of possible communication options. The communication processor may for example indicate to the user via the website that is delivered by the application server what types of device data may be sent from the signal processing device to the management server. Of course, the communication processor may be configured to transmit certain device data automatically to the management server.

In addition, or as alternative, the communication processor may indicate to the user, which device data may be retrieved from the management server, and the user may then select to retrieve the device data that the user requires. Of course, the communication processor may be configured to automatically retrieve certain device data from the management server.

In such embodiments, the signal processing device serves as a kind of communication hub that retrieves the information or data and generates the respective website for display to a user via a web browser.

Alternatively or in addition, the signal processing device may also comprise a user interface with a display and a web browser application that is shown on the display of the user interface to the user. In this case, the application server and the client, i.e., the web browser application, may be executed within the signal processing device.

Generally, the client or web browser may be executed on any device that may communicatively couple to the signal processing device. Such devices may comprise computers, like desktop computers, laptops or tablet-PCs. Such devices may also comprise smartphones or other capable devices.

In embodiments, the management server or the gateway may comprise an application server that may deliver the website to a browser application. In such embodiments, a user will call the website via the address of the management server or the gateway. Similarly as explained above for the communication processor and the application server in the signal processing device, the management server or the gateway may contact the signal processing device and retrieve the available device data and display the available device data to the user via the website. It is understood, that the above-presented explanations regarding the operation of the application server in the signal processing device apply mutatis mutandis to the management server or the gateway when delivering the website via the management server or the gateway.

In embodiments, instead of retrieving or exchanging the device data via the communication processor in the signal processing device and displaying the data on the website, the device data may also be managed user-side e.g., in the website that is displayed by the browser application. Such a website may include functions that at least one of retrieve the device data from the management server and forward the device data to the signal processing device, and that retrieve the device data from the signal processing device and forward the device data to the management server. The application server and the website provided by the application server may for example use cross origin resource sharing, CORS, to implement the inclusion of data from the management server while the website is delivered by the application server in the signal processing device or vice versa. With CORS it is possible to request or load restricted resources on a website that are to be requested from another domain outside the domain from which the website was served. A website may usually embed cross-origin objects, like images, stylesheets, scripts, iframes, and videos. However, certain requests, like for example Ajax requests, are usually forbidden to be loaded by default by the so called “same-origin security policy”. CORS defines a way for a browser and a server to allow the cross-origin request. This may be used in the context of the present disclosure to allow a web browser that displays the website to load device data either from the signal processing device or the management server, even if the website is not delivered from that device.

As already indicated above, any communication between the signal processing device and the management server may be performed directly or via the gateway. This of course also applies if the application server is present in the signal processing device or the management server, and device data is retrieved either from the management server or the signal processing device or via the website when viewed or executed with a web browser by a user.

In embodiments, the website may comprise functions to open multiple windows or tabs in the browser that displays the website. The website may for example comprise a main site, that may list all possible devices i.e., all signal processing devices of a user that are coupled to a specific management server.

When a user selects one of the signal processing devices, an additional window or tab may open that displays a second website, also called device site, that shows the details of the respective signal processing devices.

The management server may comprise a list of signal processing devices that are coupled to the respective management server. For example, a unique identifier or UUID may be determined for every signal processing device and the management server may store the UUIDs of all associated signal processing devices. Of course, the management server may store further information for every signal processing device, like for example a network address of the respective device or a network address of a gateway that allows reaching the respective signal processing device. The management server may also store any of the received device data for a respective signal processing device.

In an embodiment, the communication processor of the gateway may provide functionality that extends over the functionality of a known network gateway that may forward data packets between two networks. The gateway may instead act public network-side like a server and provide the requested information via its own interface, for example a REST API, a Corba or SOAP interface, a website or any proprietary interface. The communication processor of the gateway may to this end actively request the device data from the signal processing devices prior to sending the device data to the source of the request. In contrast to a standard gateway, the gateway according to the present disclosure not necessarily forwards data packets directly to the respective signal processing device, but handles the data packets internally and communicates with the signal processing devices separately to answer any request.

In an embodiment, the communication processor of the gateway may comprise an application server for exchanging the device data via at least one of HTTP-based communication, REST-based, SOAP-based communication, and Corba-based communication.

With regard to the application server in the gateway, the above explanations regarding the application server in the signal processing device apply mutatis mutandis. The application server of the gateway may therefore communicate via any of the above-mentioned technologies or via any proprietary protocol.

As indicated above, a website may be served by the application server and that website may either comprise device data that is retrieved by the gateway or may comprise functions that allow the device that displays the website to retrieve the device data.

In yet another embodiment, the communication processor of the gateway may retrieve device information about the at least one signal processing device from the management server and may communicate with the at least one signal processing device based on the retrieved device information.

As indicated above, the communication processor may act like a man-in-the-middle and block direct access to the signal processing devices. To this end, the communication processor may retrieve information about the respective signal processing devices from the management server and then access the single signal processing devices accordingly. As indicated above, the management server may store a list of all available signal processing devices. Of course, the communication processor of the gateway may also provide encryption functions to perform an encrypted data transfer.

In another embodiment, the gateway may comprise a device list, wherein the communication processor may scan for the at least one signal processing device via the device communication interface and may store device information about any signal processing device that is detected during the scan in the device list. The communication processor may communicate with at least one of the at least one signal processing device and the management server based on the device information stored in the device list.

The device list may be stored in a memory of the gateway. For example, the device list may be provided as a variable, multiple variables or an array of variables in a computer program that is executed by a processing element of the gateway.

Instead of loading a list of available devices from the management server, the communication processor of the gateway may actively scan for the signal processing devices that may be available via the device communication interface. Scanning for all available signal processing devices allows accessing signal processing devices that are not yet included in the list that is stored in the management server.

The gateway may comprise a device input section that allows a user to input device information about the at least one signal processing device, for example a network address of a signal processing device. The communication processor may then communicate with the at least one signal processing device based on the device information input by the user.

In a further embodiment, the gateway may comprise an application processor for executing data processing applications on data received from the at least one signal processing device based on instructions received from at least one of the at least one signal processing device and the management server and a user via the user interface.

The application processor allows offloading of processing tasks from the single signal processing devices to the gateway. The gateway may therefore act like an external processing power upgrade to the signal processing devices.

In embodiments, the gateway may also forward the data received from the at least one signal processing device and the instructions received from at least one signal processing device to the management server for execution of the respective processing tasks in the management server.

Of course, the signal processing devices may also transmit the data and the instructions directly to the management server.

In an embodiment, the gateway may comprise a device data memory for storing data received from at least one of the at least one signal processing device and the management server.

The device data memory allows the gateway to act as a cache or temporary storage for the device data. Since the gateway will usually be provided with the signal processing devices in the same network, the gateway will be accessible for the signal processing devices permanently. The signal processing device may therefore provide the device data to the gateway whenever it is adequate for the signal processing devices or for example requested by a user. The gateway may then either directly forward the device data to the management server or store the device data in the device data memory until the management server is accessible.

In an embodiment, the management server may comprise a control interface for receiving control commands. The communication processor of the management server may exchange device data based on control commands received via the control interface.

In an embodiment, the control interface may be provided as a control application that may be executed in a web browser application i.e., as a website that is displayed in a web browser. To this end, the control interface may comprise an application server that serves the website for display by a web browser in a user device. The above-presented explanations regarding the application server of the gateway or the signal processing device apply mutatis mutandis to the application server of the management server. The application server of the management server may therefore comprise a HTTP-based, a SOAP or Corba interface or any type of proprietary interface.

The control application may show a device list of signal processing devices that are coupled to the management server. A user may then select one or multiple of the shown signal processing devices to exchange device data with these devices. In an embodiment, the control application may provide the user with a function to add or remove signal processing devices from the device list. This may be done as explained above, by adding network addresses or via unique identifiers for every signal processing device.

The control application may also communicate in the background with the respective signal processing device and retrieve device data that may then be shown in the web browser application to the user. This background communication may also be called a kind of cross-site-scripting, since the device data is requested from the signal processing device and is then shown via a web application of the management server.

As explained above, the user may alternatively open a web-based application that is provided by one of the single signal processing devices to control the signal processing device. Of course, the respective signal processing device may communicate in the background with the management server to request data from the management server that may then be shown to the user in the web-browser via the signal processing device.

### BRIEF DESCRIPTION OF THE DRAWINGS

For a more complete understanding of the present disclosure and advantages thereof, reference is now made to the following description taken in conjunction with the accompanying drawings. The disclosure is explained in more detail below using exemplary embodiments which are specified in the schematic figures of the drawings, in which:

FIG. 1 shows a block diagram of an embodiment of a signal processing device according to the present disclosure;

FIG. 2 shows a block diagram of an embodiment of a gateway according to the present disclosure;

FIG. 3 shows a block diagram of an embodiment of a management server according to the present disclosure;

FIG. 4 shows a flow diagram of an embodiment of a method according to the present disclosure; and

FIG. 5 shows a block diagram of another embodiment of a signal processing device according to the present disclosure;

FIG. 6 shows a block diagram of another embodiment of a signal processing device according to the present disclosure;

FIG. 7 shows a block diagram of an embodiment of a device management system according to the present disclosure; and

FIG. 8 shows a block diagram of an embodiment of an oscilloscope as a signal processing device according to the present disclosure.

In the figures like reference signs denote like elements unless stated otherwise.

### DETAILED DESCRIPTION OF THE DRAWINGS

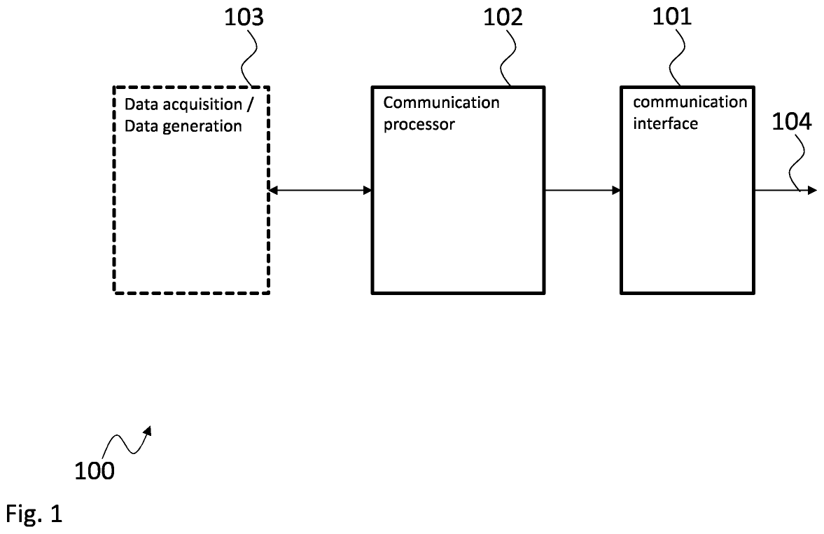

FIG. 1 shows a block diagram of a signal processing device 100. The signal processing device 100 comprises a communication interface 101 and a communication processor 102 that is coupled to the communication interface 101. Optionally, the signal processing device 100 may comprise additional data acquisition circuitry or data/signal generation circuitry 103, shown in dashed lines.

The communication interface 101 may be implemented at least in part as a hardware interface, like for example an Ethernet interface or a WIFI interface, or any other electrical interface capable of transmitting digital data. The communication processor 102 may interact with the communication interface 101 accordingly to transmit and receive device data 104.

The communication interface 101 may also at least in part comprise computer readable instructions that may be provided e.g., in form of callable functions or functions of a firmware or operating system of the signal processing device 100, and that may be used by the communication processor 102 to transmit and receive the device data 104

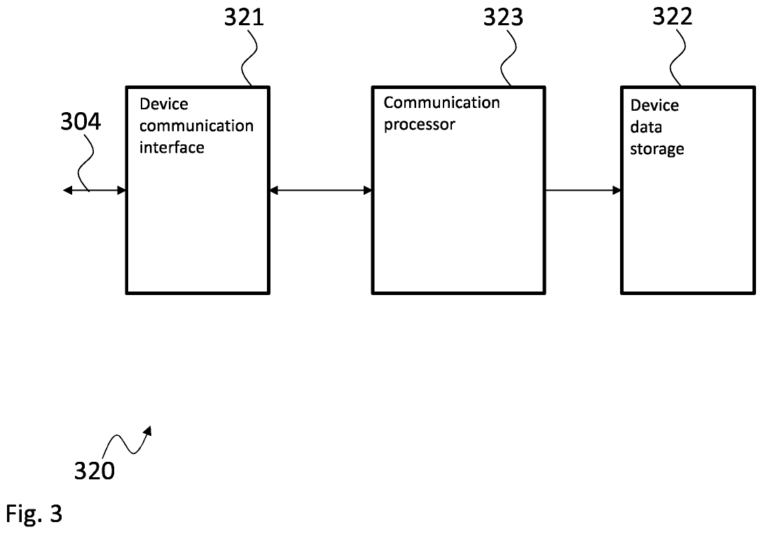

The communication processor 102 serves in the signal processing device 100 to exchange device data 104 with a management server like for example shown in FIG. 3. As explained above, the device data 104 may comprise any type of data that is related to the operation of the signal processing device 100 or to data measured or generated with the signal processing device 100.

Such device data 104 may, therefore, comprise status information, updates for the firmware or for additional application software or for parameters of the signal processing device, log files and crash reports of the signal processing device, health data, utilization data, service data, and raw data i.e., data representing measured signals or generated signals.

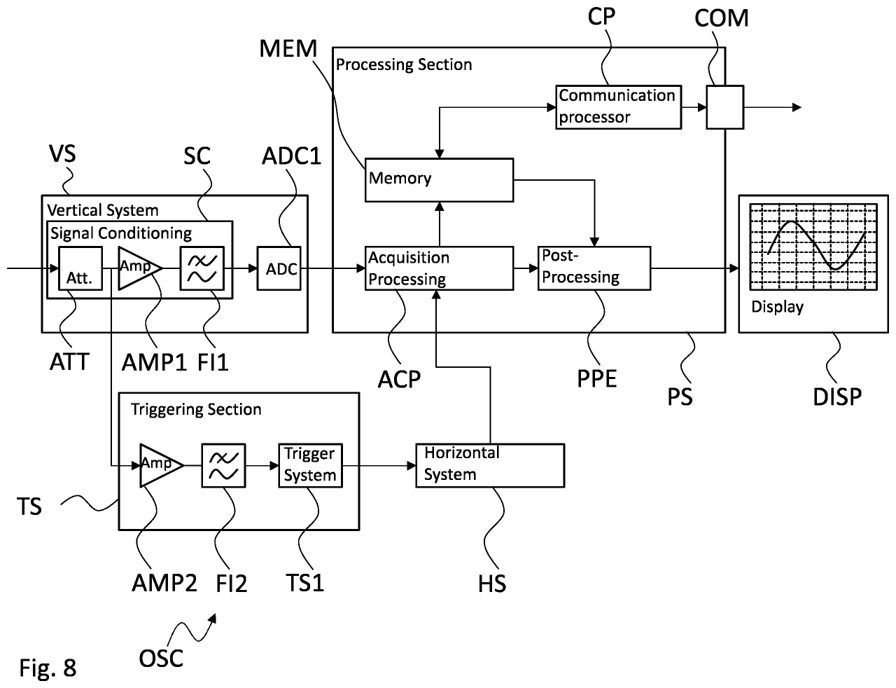

Although not shown in more detail, it is understood that the data acquisition circuitry or data/signal generation circuitry 103 may be any kind of circuitry that allows generating signals or measuring or acquiring signals with the signal processing device 100, like for example the data generation circuitry of a signal generator or the data acquisition circuitry of an oscilloscope, a bus analyzer or a vector network analyzer. A more detailed example of a possible data acquisition circuitry 103 is shown in FIG. 8.

It is understood, that the communication processor 102 may be integrated or may be provided as part of another processing element that may be provided in the signal processing device 100 for performing other tasks in the signal processing device 100. Such a processing element may for example be a processor of the signal processing device 100 that serves for managing the general functionality of the signal processing device 100, like displaying data to a user on a display, and receiving user input.

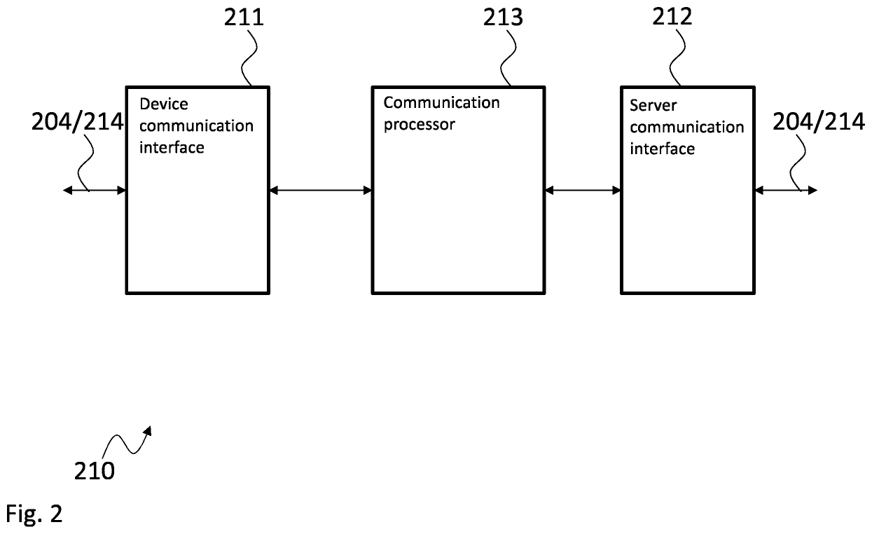

FIG. 2 shows a block diagram of a gateway 210. The gateway 210 comprises a device communication interface 211, a server communication interface 212, and a communication processor 213 that is communicatively coupled between the device communication interface 211 and the server communication interface 212.

The device communication interface 211 and the server communication interface 212 may receive and transmit requests 214 and device data 204.

As explained above, the requests 214 may comprise requests 214 initiated by the signal processing device when initiating a communication with the management server, or by the management server when initiating a communication with the signal processing device. The requests 214 may also be initiated by a user e.g., via a respective website. The requests 214 may have any adequate form, depending on the interface that the gateway 210 provides.

If the communication processor 213 provides a REST-based communication interface, the requests 214 may comprise respective HTTP requests 214. The communication processor 213 may also provide a Corba- or SOAP-based interface and the requests 214 may comprise respective Corba- or SOAP-based requests. Of course, other types of interfaces are also possible.

In embodiments, the gateway 210 may be a component that is not actively used by a user and is interconnected between the signal processing device and the management server to automatically perform the required communication functions, like retrieving device data 204 from the signal processing device and forwarding the device data 204 to the management server and vice versa.

In other embodiments, the gateway 210 may comprise a user interface for a user to initiate the communication between the signal processing device and the management server. The gateway 210 may for example comprise a computer, like a PC or Laptop, and a user may be provided with the user interface in the form of a website shown by a browser application on the display of the computer. Of course, the website may be served by the management server or the signal processing device or locally by the gateway 210.

FIG. 3 shows a block diagram of a management server 320. The management server 320 comprises a device communication interface 321 that is coupled to a communication processor 323. The communication processor 323 is further coupled to a device data storage 322.

The device communication interface 321 serves for sending and receiving device data 304. The device data 304 may comprise any of the above-mentioned types of data and may be sent by the management server 320 or may be received by the management server 320.

It is understood, that the management server 320 may be provided as a dedicated server device, for example a server in a data center or on premises of the manufacturer of the signal processing device. The management server 320 may also comprise a combination of multiple hardware devices, like multiple servers, multiple network attached storages and the like. In other embodiments, the management server 320 may also be provided as a virtualized or cloud server. Of course, the device communication interface 321 may be the respective interface as provided by the underlying hardware platform.

As explained above, the management server 320 may provide a central management and data storage for multiple signal processing devices. The management server 320 may, therefore, store the device data in the device data storage 322. This device data storage 322 may comprise any type of adequate storage or memory, like a hard drive, RAM, ROM and the like. The device data storage 322 may of course also be provided by the underlying hardware architecture.

The communication processor 323 may in embodiments be implemented as a communication application or server application that receives and transmits the device data 304 and that comprises respective computer readable instructions that are stored in the memory and are executed by a processor of the underling hardware e.g., in the context of an operating system that is executed in the processor.

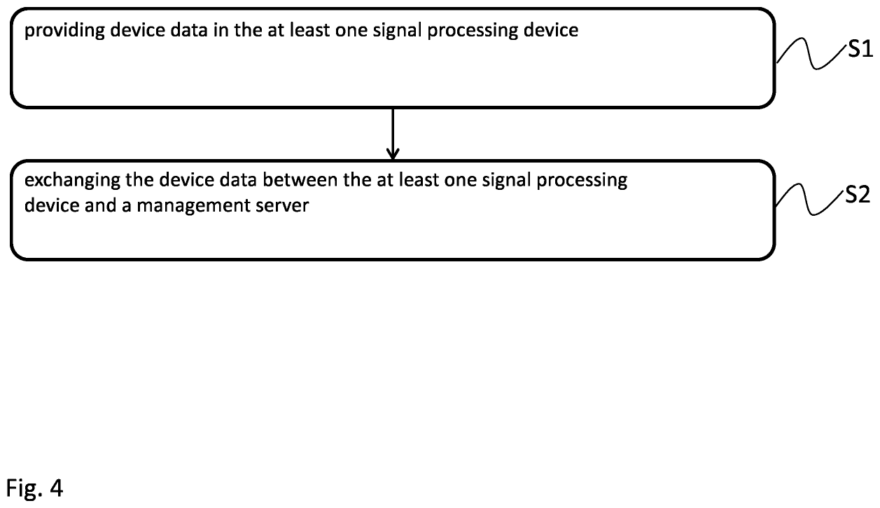

FIG. 4 shows a flow diagram of a method for managing at least one signal processing device.

The method comprises providing 51 device data in the at least one signal processing device, and exchanging S2 the device data between the at least one signal processing device and a management server.

The step 51 of providing device data may comprise providing identification data for the respective signal processing device. The identification data may then be provided to the management server for identifying the respective signal processing device.

After identifying a respective signal processing device, the management server may then provide device data on request or automatically without further request. Of course, in the context of the method according to the present disclosure, the device data may comprise any type of device data as describe in the present disclosure.

The device data may be exchanged S2 between the signal processing device and the management server directly. In embodiments, the device data may also be exchanged S2 indirectly via a gateway, for example via a gateway 210 as described above.

In embodiments, the data exchange S2 between the at least one signal processing device and the management server is controlled by a data controller. The data controller may control the data exchange based on a predefined set of communication rules. The data controller may act like a firewall that is configured for a secure communication between the signal processing device and the management server.

The data controller may for example allow TCP-based communication only via specific ports and for specific network addresses.

In embodiments, the data controller may be provided in the signal processing device or in the gateway. The data controller may be coupled to the signal processing devices via a local network. At the same time, the data controller may provide a protected communication, like for example a VPN or a tunnel to the management server via a public network, like the internet.

In embodiments, the device data may be stored in the at least one signal processing device or in a gateway that is communicatively coupled between the at least one signal processing device and the management server prior to exchanging the device data.

Storing the device data allows keeping device data for later transmission if the communication to the management server is momentarily not possible. Storing the device data my also be seen as a kind of caching for the device data.

As indicated above, a website may be provided by the at least one signal processing device or the management server for management of the data exchange by a user. Of course, the website may also be provided by the gateway.

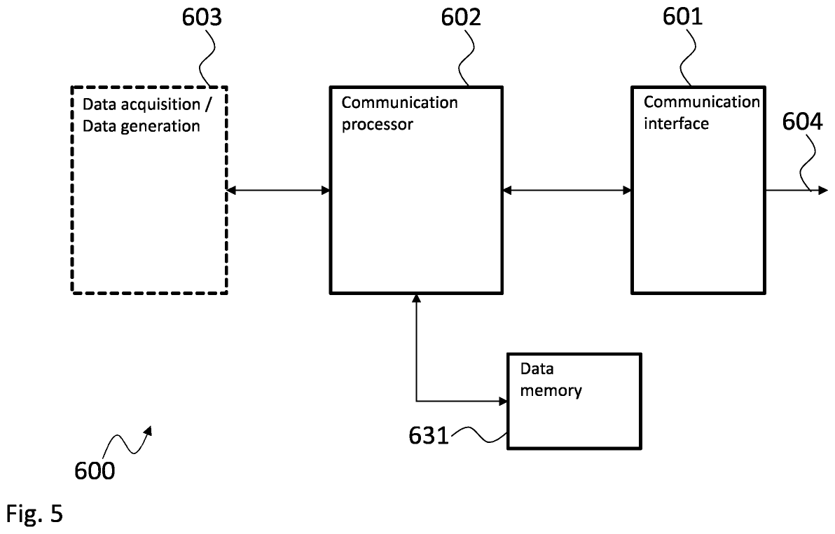

FIG. 5 shows a block diagram of another signal processing device 600. The signal processing device 600 is based on the signal processing device 100 and comprises a communication interface 601, a data memory 631 and a communication processor 602 that is coupled to the communication interface 601 and the data memory 631. Optionally, the signal processing device 600 may comprise additional data acquisition circuitry or data/signal generation circuitry 603, shown in dashed lines. It is understood, that all explanations regarding the signal processing device 100 also apply to the signal processing device 600.

The data memory 631 in the signal processing device 600 serves as a temporary storage or cache for the device data 604. The data memory 631 may for example be used by the communication processor 602 to store device data 604 that is collected or otherwise generated in the signal processing device 600 for later delivery to the management server via the communication interface 601.

Of course, the data memory 631 may also be used by the communication processor 602 to store device data 604 that may be sent from the management server to the signal processing device 600. For example, firmware updates, application updates, and documents, like application notes, may be sent by the management server to the signal processing device 600 in the background i.e., while the user is not actively requesting such device data 604. The signal processing device 600 may store the received device data 604 in the data memory 631 until a user requests this device data 604 or until the user is informed about the availability of this device data 604.

It is understood, that a data memory may also be provided in the gateway. A gateway comprising such a data memory may perform all of the above-described functions with the data memory for a single or for multiple signal processing devices. In such a gateway the data memory may be coupled to the communication processor of the gateway.

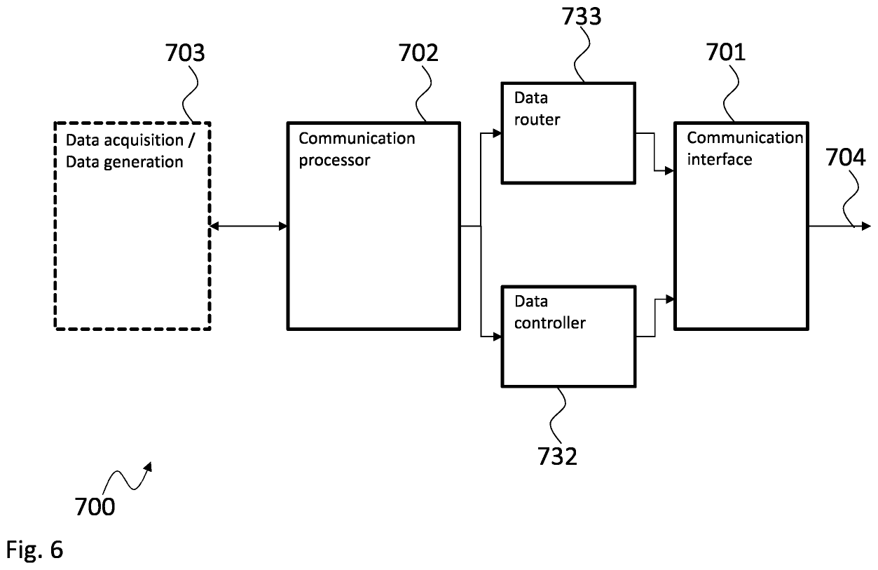

FIG. 6 shows a block diagram of another embodiment of a signal processing device 700. The signal processing device 700 is based on the signal processing device 100 and comprises a communication interface 701, a communication processor 702, and a data router 733 and a data controller 732 that are communicatively coupled between the communication processor 702 and the communication interface 701. Optionally, the signal processing device 700 may comprise additional data acquisition circuitry or data/signal generation circuitry 703, shown in dashed lines. It is understood, that all explanations regarding the signal processing device 100 also apply to the signal processing device 700, and that at least some of the elements of the signal processing device 700 may be combined with some of the elements of the signal processing device 600.

As explained above, the data controller 732 of the signal processing device 700 may be implemented as a firewall or act as a kind of firewall. Of course, such a firewall may be implemented as combination of hardware and software, for example as a computer module with its own communication interfaces, a processor and a firewall operating system. In embodiments, the data controller 732 may also be implemented at least in part as a computer program comprising computer readable instructions that may be stored in a memory and that are executed by the communication processor 702.

The data router 733 may provide the functionality of an active network element that forwards data from a management server or a gateway to further signal processing devices that may be coupled to the signal processing device 700 and from these signal processing devices to a management server or the gateway.

In the signal processing device 700 the data router 733 and the data controller 732 are both coupled to the same communication interface 701. In such an embodiment, the data controller 732 and the data router 733 may both communicate via the same network without any additional measures. However, in that network a firewall may block any traffic from external networks to the other signal processing devices.

As alternative, in such an embodiment, the data router 733 may for example communicate with the other signal processing devices in a specific VLAN, and the data controller 732 may communicate with the gateway or the management server via another VLAN.

In other embodiments, dedicated communication interfaces may be provided for the data controller 732 and the data router 733.

It is understood, that a data controller and a data router may also be provided in the gateway. A gateway comprising such a data controller and data router may perform all of the above-described functions of the data controller and the data router for a single or for multiple signal processing devices. In such a gateway the data controller and the data router may be coupled to the communication processor of the gateway and one or multiple communication interfaces of the gateway.

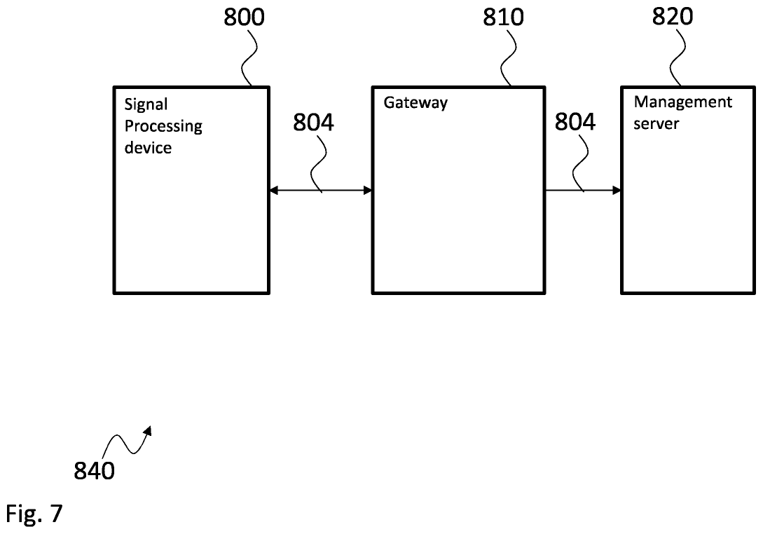

FIG. 7 shows a block diagram of an embodiment of a device management system 840. The device management system 840 comprises a signal processing device 800 that is coupled to a gateway 810. The gateway 810 is further coupled to a management server 820. It is understood, that the gateway 810 is optional and that the signal processing device 800 may communicate directly with the management server 820.

The signal processing device 800, the management server 820 and the gateway 810 may be implemented according to any of the embodiments described in the present disclosure.

Especially, in at least one of the signal processing device 800, the management server 820 and the gateway 810 an application server may be provided that serves a website and that allows a user to control the device data exchange between the signal processing device 800 and the management server 820 according to any of the above-describes implementations

FIG. 8 shows a block diagram of an oscilloscope OSC that may be an implementation of a signal processing device according to the present disclosure. The oscilloscope OSC is implemented as a digital oscilloscope. However, the present disclosure may also be implemented with any other type of oscilloscope.

The oscilloscope OSC exemplarily comprises five general sections, the vertical system VS, the triggering section TS, the horizontal system HS, the processing section PS and the display DISP. It is understood, that the partitioning into five general sections is a logical partitioning and does not limit the placement and implementation of any of the elements of the oscilloscope OSC in any way.

The vertical system VS mainly serves for attenuating or amplifying a signal to be acquired. The signal may for example be modified to fit the signal in the available space on the display DISP or to comprise a vertical size as configured by a user.

To this end, the vertical system VS comprises a signal conditioning section SC with an attenuator ATT that is coupled to an amplifier AMP1. The amplifier AMP1 is coupled to a filter FI1, which in the shown example is provided as a low pass filter. The vertical system VS also comprises an analog-to-digital converter ADC1 that receives the output from the filter FI1 and converts the received analog signal into a digital signal.

The attenuator ATT and the amplifier AMP1 serve to scale the waveform of the signal and to condition the amplitude of the signal to be acquired to match the operation range of the analog-to-digital converter ADC1. The filter FI1 serves to filter out unwanted high frequency components of the signal to be acquired.

The triggering section TS comprises an amplifier AMP2 that is coupled to a filter F12, which in this embodiment is implemented as a low pass filter. The filter FI2 is coupled to a trigger system TS1.

The triggering section TS serves to capture predefined signal events and allows the horizontal system HS to e.g., display a stable view of a repeating waveform, or to simply display waveform sections that comprise the respective signal event. It is understood, that the predefined signal event may be configured by a user via a user input of the oscilloscope OSC.

Possible predefined signal events may for example include, but are not limited to, when the signal crosses a predefined trigger threshold in a predefined direction i.e., with a rising or falling slope. Such a trigger condition is also called an edge trigger. Another trigger condition is called “glitch triggering” and triggers, when a pulse occurs in the signal to be acquired that has a width that is greater than or less than a predefined amount of time.

The triggering section TS operates on the signal as provided by the attenuator ATT, which is fed into the amplifier AMP2. The amplifier AMP2 serves to condition the input signal to the operating range of the trigger system TS1. It is understood, that a common amplifier may also be used instead of the dedicated amplifiers AMP1 and AMP2.

In order to allow an exact matching of the trigger event and the waveform that is shown on the display DISP, a common time base may be provided for the analog-to-digital converter ADC1 and the trigger system TS1.

It is understood, that although not explicitly shown, the trigger system TS1 may comprise at least one of <configurable voltage comparators for setting the trigger threshold voltage, fixed voltage sources for setting the required slope, respective logic gates like e.g., a XOR gate, and Flipflops to generate the triggering signal.

The triggering section TS is exemplarily provided as an analog trigger section. It is understood, that the oscilloscope OSC may also be provided with a digital triggering section. Such a digital triggering section will not operate on the analog signal as provided by the attenuator ATT but will operate on the digital signal as provided by the analog-to-digital converter ADC1.

A digital triggering section may comprise a processing element, like a processor, a DSP, a CPLD or an FPGA to implement digital algorithms that detect a valid trigger event.

The horizontal system HS is coupled to the output of the trigger system TS1 and mainly serves to position and scale the signal to be acquired horizontally on the display DISP.

The oscilloscope OSC further comprises a processing section PS that implements digital signal processing and data storage for the oscilloscope OSC. The processing section PS comprises an acquisition processing element ACP that is couple to the output of the analog-to-digital converter ADC1 and the output of the horizontal system HS as well as to a memory MEM and a post processing element PPE.

The acquisition processing element ACP manages the acquisition of digital data from the analog-to-digital converter ADC1 and the storage of the data in the memory MEM. The acquisition processing element ACP may for example comprise a processing element with a digital interface to the analog-to-digital converter ADC1 and a digital interface to the memory MEM. The processing element may for example comprise a microcontroller, a DSP, a CPLD or an FPGA with respective interfaces. In a microcontroller or DSP, the functionality of the acquisition processing element ACP may be implemented as computer readable instructions that are executed by a CPU. In a CPLD or FPGA the functionality of the acquisition processing element ACP may be configured in to the CPLD or FPGA.

The post processing element PPE may be controlled by the acquisition processing element ACP and may access the memory MEM to retrieve data that is to be displayed on the display DISP. The post processing element PPE may condition the data stored in the memory MEM such that the display DISP may show the data e.g., as waveform to a user.

The display DISP controls all aspects of signal representation to a user, although not explicitly shown, may comprise any component that is required to receive data to be displayed and control a display device to display the data as required.

It is understood, that even if it is not shown, the oscilloscope OSC may also comprise a user interface for a user to interact with the oscilloscope OSC. Such a user interface may comprise dedicated input elements like for example knobs and switches. At least in part the user interface may also be provided as a touch sensitive display device.

The processing section PS further comprises a communication processor CP and a communication interface COM.

The communication processor CP may be a communication processor according to any of the above-presented embodiments of the signal processing device according to the present disclosure. The communication interface COM may be a communication interface according to any of the above-presented embodiments of the signal processing device according to the present disclosure.

The communication processor CP is coupled to the memory MEM and may use the memory MEM to store and retrieve device data. The device data may also be stored in the memory MEM by other elements of the oscilloscope OSC.

Of course, the communication processor CP may also be coupled to any other element of the oscilloscope OSC to retrieve device data or to provide device data that is received from the management server.

It is understood, that all elements of the oscilloscope OSC that perform digital data processing may be provided as dedicated elements. As alternative, at least some of the above-described functions may be implemented in a single hardware element, like for example a microcontroller, DSP, CPLD or FPGA. Generally, the above-describe logical functions may be implemented in any adequate hardware element of the oscilloscope OSC and not necessarily need to be partitioned into the different sections explained above.

Although specific embodiments have been illustrated and described herein, it will be appreciated by those of ordinary skill in the art that a variety of alternate and/or equivalent implementations exist. It should be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

LIST OF REFERENCE SIGNS

| | |
|---|---|
| 100, 600, 700, 800 | signal processing device |
| 101, COM, 601, 701 | communication interface |
| 102, CP, 602, 702 | communication processor |
| 103, 603, 703 | data acquisition/data generation |
| 104, 204, 304, 604, 704 | device data |
| 210, 810 | gateway |
| 211 | device communication interface |
| 212 | server communication interface |
| 213 | communication processor |
| 214 | requests |
| 320, 820 | management server |
| 321 | device communication interface |
| 322 | device data storage |
| 323 | communication processor |
| S1, S2 | method steps |
| 631 | data memory |
| 732 | data controller |
| 733 | data router |
| 840 | device management system |
| OSC | oscilloscope |
| VS | vertical system |
| SC | signal conditioning |
| ATT | attenuator |
| AMP1 | amplifier |
| FI1 | filter |
| ADC1 | analog-to-digital converter |
| TS | triggering section |
| AMP2 | amplifier |
| FI2 | filter |
| TS1 | trigger system |
| HS | horizontal system |
| PS | processing section |
| ACP | acquisition processing element |
| MEM | memory |
| PPE | post processing element |
| DISP | display |

1. A signal processing device comprising:
a communication interface for communicatively coupling a measurement device to a management server; and
a communication processor for exchanging device data with the management server.

2. The signal processing device according to claim 1, wherein the communication processor communicates with the management server indirectly by exchanging the device data with a gateway.

3. The signal processing device according to claim 2, comprising a gateway memory for storing at least one address of the gateway, wherein the communication processor communicates with the management server indirectly by exchanging the device data with the gateway at one of the stored addresses.

4. The signal processing device according to claim 1, wherein the communication interface comprises at least one of a wired network interface or a wireless network interface and communicates within at least one of a virtual local area network, and a virtual private network.

5. The signal processing device according to claim 1, comprising a data memory that is coupled to the communication processor or integrated into the communication processor for storing outgoing device data prior to exchanging the outgoing device data with the management server.

6. The signal processing device according to claim 1, comprising a data controller that that is coupled to the communication interface and the communication processor or that is integrated into the communication processor for controlling a data flow of outgoing and incoming device data.

7. The signal processing device according to claim 6, wherein the communication interface comprises at least one of a wired network interface or a wireless network interface and communicates within at least one of a virtual local area network, and a virtual private network; and
wherein the data controller comprises a data router that communicates with other signal processing devices via at least one of the virtual local area network and the virtual private network, and with the management server directly or via a gateway over at least one of a different virtual local area network or a different virtual private network.

8. The signal processing device according to claim 1, wherein the communication processor comprises an application server for exchanging the device data via at least one of HTTP-based communication, REST-based communication, SOAP-based communication, and Corba-based communication.

9. A gateway comprising:
a device communication interface for communicating with at least one signal processing device;
a server communication interface for communicating with a management server; and
a communication processor for communicating data between the device communication interface and the server communication interface based on requests provided by at least one of the at least one signal processing device and the management server.

10. The gateway according to claim 9, wherein the communication processor comprises an application server for exchanging the device data via at least one of HTTP-based communication, REST-based, SOAP-based communication, and Corba-based communication.

11. The gateway according to claim 9, wherein the communication processor retrieves device information about the at least one signal processing device from the management server and communicates with the at least one signal processing device based on the retrieved device information.

12. The gateway according to claim 9, comprising a device list, wherein the communication processor scans for the at least one signal processing device via the device communication interface and stores device information about any signal processing device that is detected during the scan in the device list; and
wherein the communication processor communicates with at least one of the at least one signal processing device and the management server based on the device information stored in the device list.

13. The gateway according to claim 9, comprising an application processor for executing data processing applications on data received from the at least one signal processing device based on instructions received from at least one of the at least one signal processing device and the management server and a user via a user interface.

14. The gateway according to claim 9, comprising device data memory for storing data received from at least one of the at least one signal processing device and the management server.

15. A management server comprising:
a device communication interface for communicating directly or indirectly with at least one signal processing device;
a device data storage for storing device data; and
a communication processor that is coupled to the device communication interface and the device data storage for exchanging device data with the at least one signal processing device.

16. A method for managing at least one signal processing device, the method comprising:
providing device data in the at least one signal processing device; and
exchanging the device data between the at least one signal processing device and a management server.

17. The method according to claim 16, wherein the device data is exchanged between the at least one signal processing device and the management server indirectly via a gateway.

18. The method according to claim 16, wherein the data exchange between the at least one signal processing device and the management server is controlled by a data controller.

19. The method according to claim 16, wherein the device data is stored in the at least one signal processing device or in a gateway that is communicatively coupled between the at least one signal processing device and the management server prior to exchanging the device data.

20. The method according to claim 16, wherein a website is provided by the at least one signal processing device or the management server for management of the data exchange by a user.
